(19) United States
(12) Patent Application Publication
(10) Pub. No.: US 2011/0084104 A1
(43) Pub. Date: Apr. 14, 2011

(54) Vehicle roof top cargo carrier with door which detaches and transforms into a stepping stool and/or bench

(76) Inventor: Phillip Martin Long, Marble, CO (US)

(21) Appl. No.: 12/924,492

(22) Filed: Sep. 27, 2010

Related U.S. Application Data
(60) Provisional application No. 61/277,748, filed on Sep. 28, 2009.

(51) Int. Cl. B60R 9/055

(52) U.S. Cl. 224/328

(57) ABSTRACT

The invention relates to automobile roof top cargo carriers. The distinguishing feature of the invention lies in 2 main characteristics:

1) the cargo carrier utilizes an access door, which is an integral part of the body of the unit, in order to open the unit instead of the traditional “clamshell” method of opening currently utilixed by cargo boxes being sold and marketed.

2) the access door is completely removable and doubles as a bench type platform serving the primary function of supporting the user for the purpose of gaining access to the contents of the cargo carrier. The access door readily and easily transforms into a bench like platform and can be used for a wide variety of purposes, or anything the user sees fit.

### CROSS-REFERENCE TO RELATED APPLICATIONS

This application claims the benefit of provisional patent application No. 67/277,748, filed 2009 Sep. 28 by the present inventor.

### BACKGROUND

This invention relates to cargo carrying devices used on the roofs of automotive vehicles. These devices are referred to by various names such as; cargo boxes, cargo carriers, roof boxes, sport carriers, and other names. The function of the devices are to serve as a storage compartment on the roof of the vehicle and to protect the contents from the weather and debris that may be projected from the roadway or other sources.

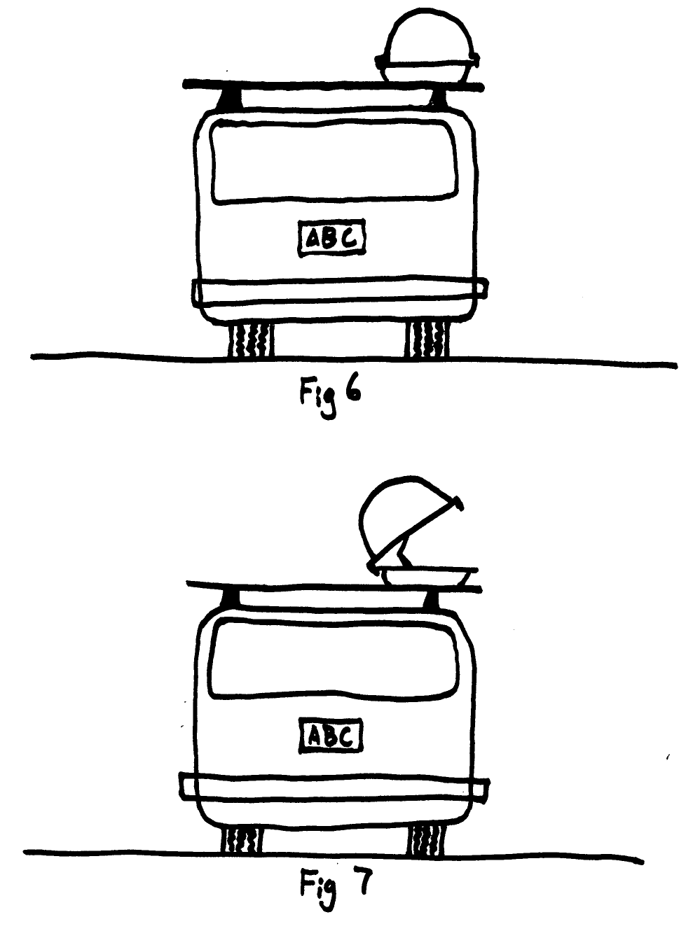

Access to these roof mounted cargo carriers can be difficult. The roof portion of most vehicles is often too high for the average person to reach while standing on the ground. In most cases, in order to stow or retrieve items from a roof box, an individual typically must stand on some portion of the vehicle such as the door entry way, the running boards, the bumper, or sometimes even the hood or roof of the vehicle itself. Not only is access to these cargo boxes difficult, but the currently used method of opening and closing them lends itself to inefficiency. The method of access currently in use by hard shell cargo boxes is of the clamshell style opening system—the cargo boxes consist of a top portion and a bottom portion which open and close in a similar manner as that of a clam. FIG. 6 is a rear view of a typical vehicle with the currently available style of cargo box in the unopened position. FIG. 7 is a rear view of a typical vehicle with the currently available style of cargo box in the opened position. This system amounts to a base portion and a lid portion, with the base typically being much smaller in capacity than the lid. Because the more voluminous lid must be closed down upon the less voluminous base, the lid is often very difficult to close. Items often become an obstruction to closing by hanging out of the base portion and interfering with the closing of the lid and base. Such obstructions can potentially exist along the entire perimeter of the cargo carrier making its closing a tedious task. Accessing obstructions along the entire perimeter in order to tuck the obstructing object inside, can prove extremely difficult and often results in people climbing on all parts of their vehicle including the hood, windshield, roof, and even the cargo carrier itself.

### DESCRIPTION

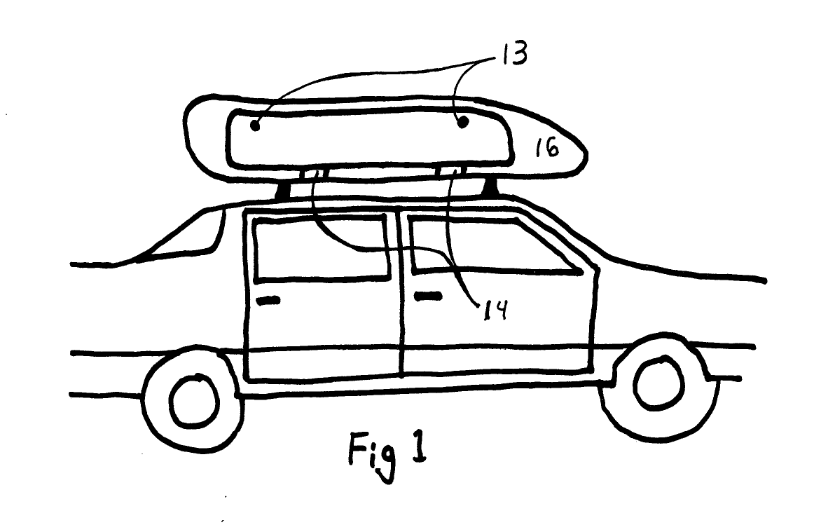

FIG. 1 is a side view of the invention, also referred to as the cargo box, with the door 12 visible. The main door has attached to it the support framework and the folded leg support assembly 12a, and the legs 12b which can be seen in subsequent figures. Also visible on FIG. 1 are the latches 13, the hinges 14,and the main body 16.

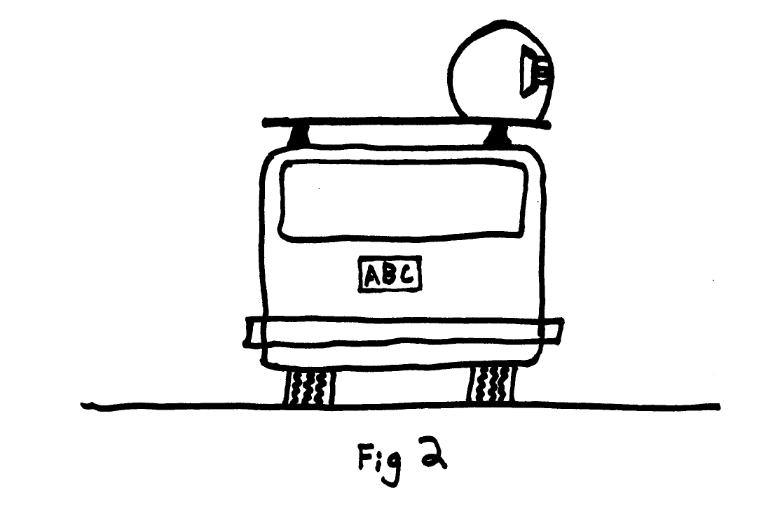

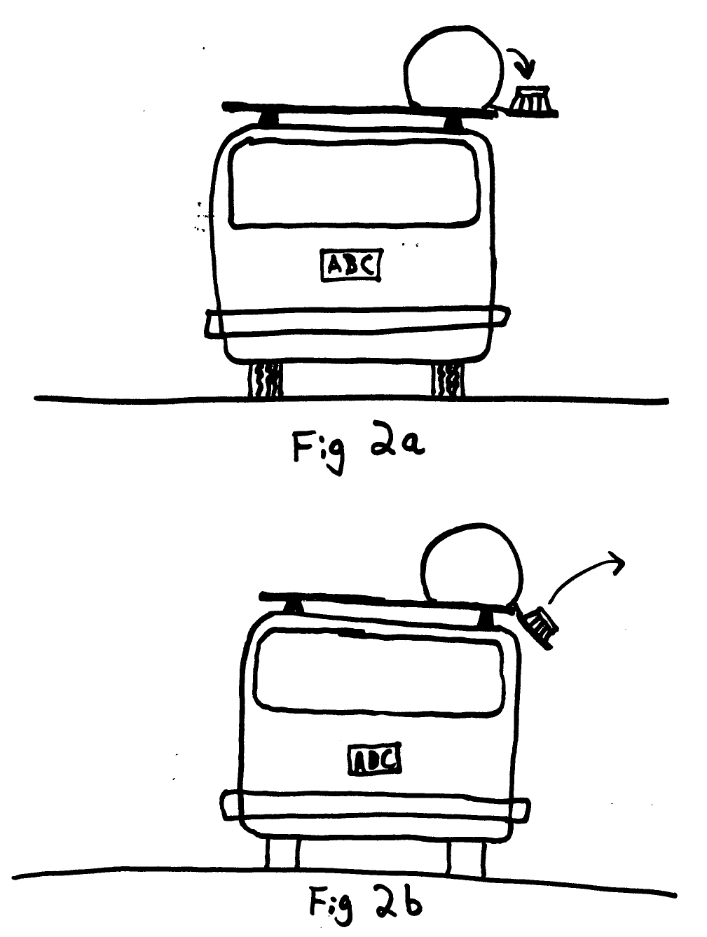

FIG. 2 is a rear view of the invention showing a profile of the support framework and the folded leg support assembly 12a on the inside of the door.

FIG. 2a shows a rear view of the invention with the door in a partially open position. The arrows indicate the swinging motion of the door.

FIG. 2b shows the a rear view of the invention in a hanging open position. The arrow indicates the movement of removing the door from the main body of the cargo box. The door can be removed from almost any degree of opening once the latches have been disengaged from the main body of the cargo box.

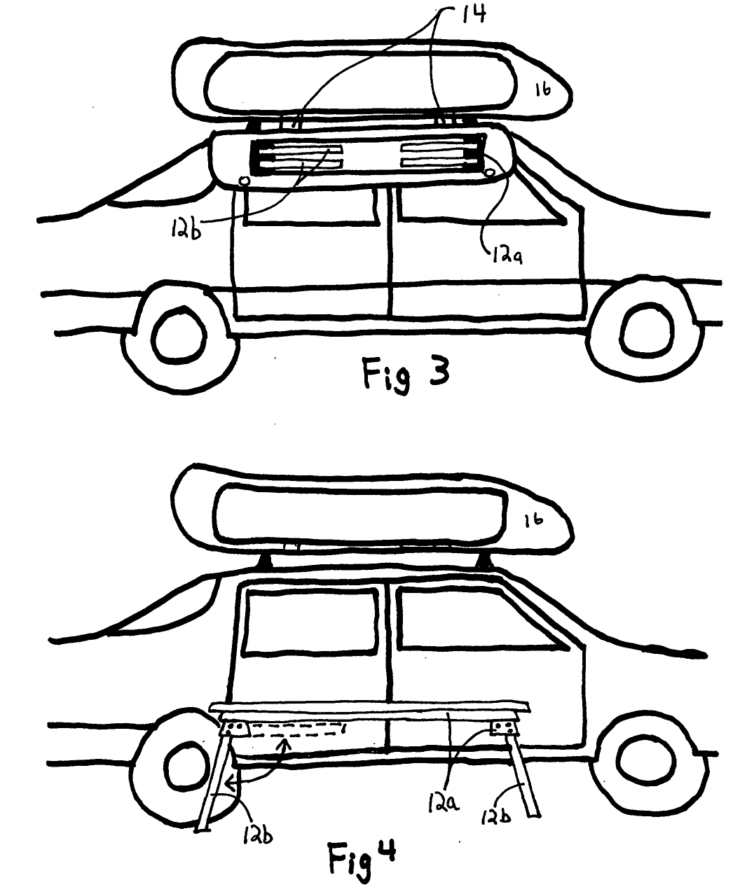

FIG. 3 shows a side view of the cargo box with the door hanging open and displaying the support framework and the folded leg support assembly 12a and the legs 12b. The door has hinges 14 which allow it to be completely removed from the main body of the cargo box. Upon removing the door, the folding set of legs can be deployed into the open position resulting in a solid stepping stool or bench type structure. The stepping stool/bench can be stood upon inorder to access the cargo box, or it can be used to sit on. The door is opened and closed by a single or a set of latches 13 which are mounted flush to the surface of the door so as not to present an obstruction.

FIG. 4 shows a side view of a vehicle with the main body of the invention 16 on the top of the vehicle and the door 12 deployed in the stool/bench configuration next to the vehicle. In this case the legs swing, noted by the arrows pointing to the left leg, into a deployed position to support the door as a platform. Other methods of support deployment may be employed.

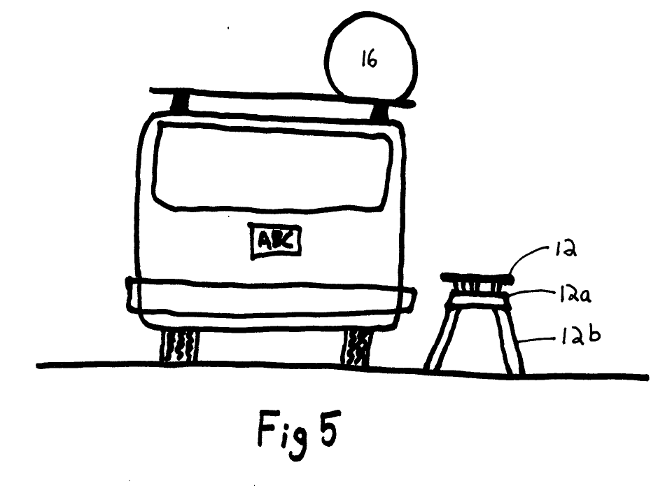

FIG. 5 shows a rear view of a vehicle with the main body of the cargo box 16 on the top of the vehicle and the door 12 deployed in the stool/bench configuration next to the vehicle. The invention can take various shapes in the same manner that current available cargo boxes come in a variety of shapes and sizes. The distinguishing feature of the invention is the fact that it has a removable door which functions to transform into a step stool/bench. The invention can have more than one door, with or without an accompanying set of legs. The legs, or similar supporting mechanism, can operate in any variety of ways to achieve the same purpose—functioning as support for the door when used in the stool/bench position.

### OPERATION

In operation one disengages the latch or latches 13 to open the door, the user can either:

a)allow the door to rest in an open position and access the interior of the roof box by standing on the ground, part of the car, or any other means, or
b) remove the door from the main body of the cargo box and proceed to unfold the legs and use the resulting step stool as a platform for standing or sitting on—or any other purpose the user sees fit.
When the user is ready to replace the door to its closed position on the main body of the cargo box, the user simply folds the legs into the stowed position, engages the door half of the hinge with the main body half of the hinge, and swings the door closed.

### SUMMARY

This invention improves accessibility of the cargo box in two main ways:

1) by substituting the clamshell style opening with a door on the side of the cargo box. A door provides easier access to any possibly protruding items in that any such items are in a reasonably easy to reach position, as opposed to the currently available clamshell style opening which has the potential for items to hang out along the entire horizontal perimeter of the cargo box. Doors can be placed on only one side or both sides of the cargo box.
2) by designing the door to be completely removable from the main body of the cargo box. The most distinctive and important feature of the invention is that connected to the interior portion of the door exists an apparatus containing a set of folding legs. When unfolded, the legs lock into a new position and thus transform the door into a platform. In turn the resulting platform is used as an apparatus to stand on in order to gain easier access to the cargo box and its contents on the roof of the vehicle. The door and its leg framework provide ample support for stowing objects in the cargo box. The door serves not only as a platform to stand on, but a bench to sit on for whatever appropriate purpose such as changing into ski boots or simply relaxing. Therefore, not only does the invention contain a built in platform which is an integral component of the cargo box, but the platform is completely portable and can be positioned anywhere it may be needed in order to most easily access contents of the cargo box or to have a bench by the campfire.

I claim:

1. A vehicle roof top cargo carrier with an opening door which completely detaches from the body of the unit and unfolds, or otherwise facilitates the easy storage of the bench supporting structure, into a stepping stool and or bench comprising:
a. a vehicle roof top cargo carrier comprising a main body and a detachable access door which serves as an integral part of the body of the roof top cargo carrier.
b. a detachable access door which can be completely removed from the main body whereby a set of legs attached or detachable to the door can be easily utilized or deployed in order to transform the door into a platform to be used for standing on, sitting on, or any other function the user chooses as appropriate.
